(19) United States
(12) Patent Application Publication
(10) Pub. No.: US 2019/0101405 A1
(43) Pub. Date: Apr. 4, 2019

(54) THREE-DIMENSIONAL DRIVING NAVIGATION DEVICE

(71) Applicant: Hua-chuang Automobile Information Technical Center Co., Ltd., New Taipei City (TW)

(72) Inventor: Hsin-Jung Feng, New Taipei City (TW)

(21) Appl. No.: 15/722,258

(22) Filed: Oct. 2, 2017

(51) Int. Cl. G01C 21/36; G08G 1/0968

(52) U.S. Cl. CPC G01C 21/3602; G01C 21/3638; G01C 21/3617; G08G 1/096861; G01C 21/365

(57) ABSTRACT

A three-dimensional driving navigation device includes a lens group, a three-dimensional image synthesis module, a GPS module, a communications module, a map information database, a processing module, and a display module. The lens group respectively photographs a plurality of external images around a vehicle. The three-dimensional image synthesis module receives the external images and synthesizes the external images into a three-dimensional panoramic projection image. The GPS module detects and outputs a real-time vehicle position. The communications module receives a history driving trajectory transferred from outside. The processing module compares the real-time vehicle position, map information, and the history driving trajectory to generate a driving path, and the processing module superimposes a virtual guide image on a position corresponding to the driving path in the three-dimensional panoramic projection image. The display module displays the three-dimensional panoramic projection image and the virtual guide image.

### BACKGROUND

### Technical Field

The present invention relates to a driving assistance device, and more particularly to a three-dimensional driving navigation device.

### Related Art

With the improvement of science and technology, electronic products are applied increasingly widely. For example, smart phones, personal digital assistants, navigation devices, and tablet computers already become popular electronic products. During driving, a driver may use an electronic product to plan a navigation path according to a current position, so that the driver travels to a destination with assistance and prompts, making the driving smoother and more convenient.

However, currently, navigation devices in fact still have some driving requirements that are yet to be met. For example, when a driver is unclear about the way and has to follow another vehicle (for example, a friend or relative's vehicle), the driver often loses the track of the other vehicle because of some driving conditions (for example, traffic jams or fast speed), resulting in trouble and danger in driving. Alternatively, when the driver wants to take a short cut as the friend does, the driver cannot achieve this by using an existing navigation device.

### SUMMARY

In view of the foregoing problem, in an embodiment, a three-dimensional driving navigation device is provided, applicable to a vehicle. The three-dimensional driving navigation device includes a lens group, a three-dimensional image synthesis module, a GPS module, a communications module, a map information database, a processing module, and a display module. The lens group includes a plurality of lenses, the lenses being respectively disposed on different positions around the vehicle, and respectively photographing a plurality of external images around the vehicle. The three-dimensional image synthesis module is connected to the lens group. The three-dimensional image synthesis module receives the external images and synthesizes the external images into a three-dimensional panoramic projection image. The GPS module detects and outputs a real-time vehicle position of the vehicle. The communications module receives a history driving trajectory transferred from outside. The map information database stores map information. The processing module is connected to the three-dimensional image synthesis module, the GPS module, the communications module, and the map information database. The processing module receives the real-time vehicle position, the history driving trajectory, the map information, and the three-dimensional panoramic projection image, and compares the real-time vehicle position, the map information, and the history driving trajectory to generate a driving path. The processing module superimposes a virtual guide image on a position corresponding to the driving path in the three-dimensional panoramic projection image. The display module is connected to the processing module. The display module displays the three-dimensional panoramic projection image and the virtual guide image.

In an embodiment, the virtual guide image may be a three-dimensional image, and a fixed distance is kept between the virtual guide image and the real-time vehicle position. Alternatively, the virtual guide image may be a trajectory line, and the virtual guide image is set along the driving path.

In an embodiment, the processing module outputs a departure signal when the real-time vehicle position departs from the driving path, so that the communications module receives a corrected driving trajectory transferred from outside. The processing module receives the corrected driving trajectory and compares the corrected driving trajectory with the map information to generate a corrected driving path. The processing module superimposes the virtual guide image on a position corresponding to the corrected driving path in the three-dimensional panoramic projection image. In an embodiment, the corrected driving path is a path for returning to the driving path, or the corrected driving path is another driving path.

In an embodiment, the three-dimensional driving navigation device may further include a navigation module, connected to the processing module. The processing module outputs a departure signal when the real-time vehicle position departs from the driving path. The navigation module receives the departure signal and correspondingly outputs a corrected navigation route for returning to the driving path. In an embodiment, the processing module further superimposes the virtual guide image on a position corresponding to the corrected navigation route in the three-dimensional panoramic projection image.

In an embodiment, the three-dimensional driving navigation device may further include an input module, connected to the communications module. The input module receives a search condition. The communications module outputs the search condition, and the history driving trajectory corresponds to the search condition.

In an embodiment, the display module may be embedded in a windshield of the vehicle, and the three-dimensional panoramic projection image and overlaps an external view in front of the vehicle.

In an embodiment, the processing module may further superimpose a direction indication image in the three-dimensional panoramic projection image according to the driving path.

In conclusion, by means of image processing and synthesis, the three-dimensional driving navigation device in the embodiments of the present invention establishes a three-dimensional panoramic projection image, and receives a history driving trajectory of another vehicle to generate a driving path, and superimposes a virtual guide image on a position corresponding to the driving path in the three-dimensional panoramic projection image, to enable a driver to intuitively travel according to a driving route of the other vehicle.

### BRIEF DESCRIPTION OF THE DRAWINGS

The present invention will become more fully understood from the detailed description given herein below for illustration only, and thus are not limitative of the present invention, and wherein:

FIG. 1 is a perspective view of a configuration of a lens group according to the present invention.

FIG. 2 is a device block diagram of a first embodiment of a three-dimensional driving navigation device according to the present invention.

FIG. 3 is a device block diagram of a second embodiment of a three-dimensional driving navigation device according to the present invention.

FIG. 4 is a schematic diagram of a panoramic projection of a three-dimensional driving navigation device according to the present invention.

FIG. 5 is a schematic diagram of a display of a first embodiment of a three-dimensional driving navigation device according to the present invention.

FIG. 6 is a schematic diagram of a display of a second embodiment of a three-dimensional driving navigation device according to the present invention.

FIG. 7 is a schematic diagram of a display of a third embodiment of a three-dimensional driving navigation device according to the present invention.

FIG. 8 is a schematic diagram of a display of a fourth embodiment of a three-dimensional driving navigation device according to the present invention.

### DETAILED DESCRIPTION

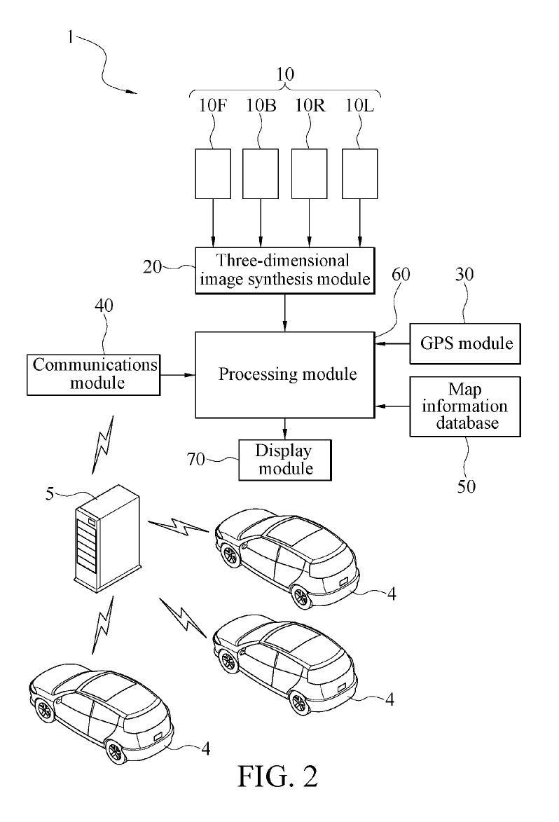

Referring to FIG. 2, in this embodiment, a three-dimensional driving navigation device 1 is applied to a vehicle 2 and includes a lens group 10, a three-dimensional image synthesis module 20, a GPS module 30, a communications module 40, a map information database 50, a processing module 60, and a display module 70.

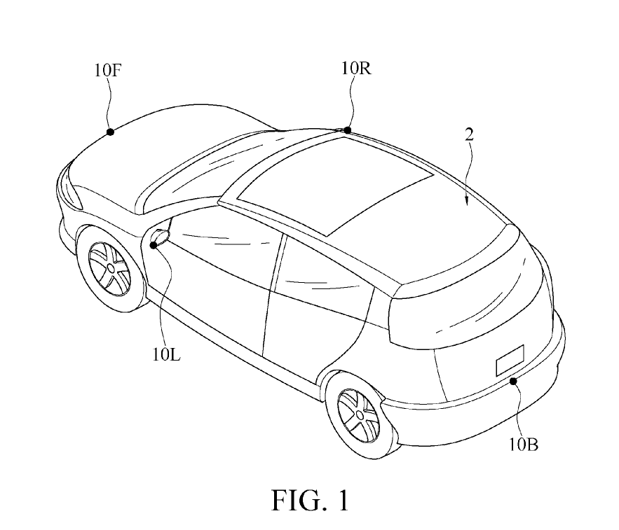

As shown in FIG. 1, in this embodiment, the lens group 10 includes a front-view lens 10F, a rear-view lens 10B, a left-view lens 10L, and a right-view lens 10R. The front-view lens 10F is mounted in the front of the vehicle 2. For example, the front-view lens 10F may be disposed on a hood or at a hood scoop in the front, so as to photograph a vehicle-body front-side image I_{F}. The rear-view lens 10B is mounted in the rear of the vehicle 2. For example, the rear-view lens 10B may be disposed on a trunk cover, to photograph a vehicle-body rear-side image I_{B}. The left-view lens 10L and the right-view lens 10R are respectively mounted on a left side and a right side of the vehicle 2. For example, the left-view lens 10L is mounted on a left side-view mirror to photograph a vehicle-body left-side image I_{L}. The right-view lens 10R may be mounted on a right side-view mirror to photograph a vehicle-body right-side image I_{R}. In fact, the quantity and angles of the lenses may all be adjusted according to an actual requirement. The foregoing description is only an example, but is not intended to constitute any limitation.

In addition, the front-view lens 10F, the rear-view lens 10B, the left-view lens 10L, and the right-view lens 10R may be specifically wide-angle lenses or fisheye lenses. The vehicle-body front-side image I_{F}, the vehicle-body rear-side image I_{B}, the vehicle-body left-side image I_{L}, and the vehicle-body right-side image I_{R} at least partially overlap each other. That is, the vehicle-body front-side image I_{F}, the vehicle-body rear-side image I_{B}, the vehicle-body left-side image I_{L}, and the vehicle-body right-side image I_{R} all partially overlap each other without any gap, so as to obtain a complete image around the vehicle 2. The lens group 10 outputs the vehicle-body front-side image I_{F}, the vehicle-body rear-side image I_{B}, the vehicle-body left-side image I_{L}, and the vehicle-body right-side image I_{R}.

The three-dimensional image synthesis module 20 may be specifically implemented by using a microcomputer, a processor or a dedicated chip, and the three-dimensional image synthesis module 20 may be mounted on the vehicle 2. The three-dimensional image synthesis module 20 is connected to the front-view lens 10F, the rear-view lens 10B, the left-view lens 10L, and the right-view lens 10R. The three-dimensional image synthesis module 20 receives and may first combine the vehicle-body front-side image I_{F}, the vehicle-body rear-side image I_{B}, the vehicle-body left-side image I_{L}, and the vehicle-body right-side image I_{R} into a planar panoramic image, then synthesizes the planar panoramic image into a three-dimensional panoramic projection image Iₛᵤᵣᵣ by using a back projection manner, and outputs the three-dimensional panoramic projection image Iₛᵤᵣᵣ.

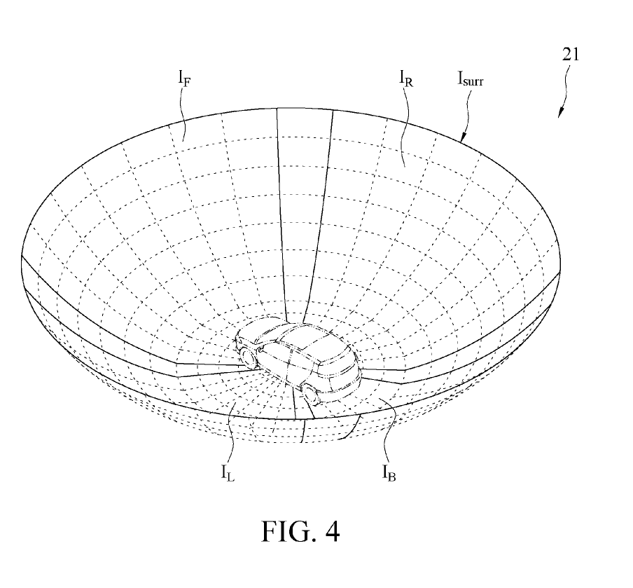

Alternatively, referring to FIG. 4, in this embodiment, the three-dimensional image synthesis module 20 projects the vehicle-body front-side image I_{F}, the vehicle-body rear-side image I_{B}, the vehicle-body left-side image I_{L}, and the vehicle-body right-side image I_{R} onto a 3D panoramic model 21 to synthesize the three-dimensional panoramic projection image Iₛᵤᵣᵣ. Edges of the projections of the vehicle-body front-side image I_{F}, the vehicle-body rear-side image I_{B}, the vehicle-body left-side image I_{L}, and the vehicle-body right-side image I_{R} onto the 3D panoramic model 21 overlap each other. Therefore, the three-dimensional panoramic projection image Iₛᵤᵣᵣ may present a 3D around-view image around the vehicle 2. That is, the three-dimensional panoramic projection image Iₛᵤᵣᵣ further provides three-dimensional perception to realistically present the surrounding environment of the vehicle, so as to enable a driver to easily and intuitively recognize a height difference of a nearby object and a distance from the nearby object.

The GPS module 30 may be specifically implemented by using a microcomputer, a processor or a dedicated chip and mounted in the vehicle 2, so as to detect and output a real-time vehicle position (that is, the position of the vehicle 2) by using a satellite. In some embodiments, the GPS module 30 may be located in a wearable device (for example, a watch or wristband) worn by a driver or an electronic product (for example, a smart phone or a tablet computer).

The communications module 40 receives a history driving trajectory transferred from outside. In an embodiment, the history driving trajectory may be formed of a plurality of history driving positions (that is, previous GPS positions) of an external vehicle 4. As shown in FIG. 2, in this embodiment, each external vehicle 4 may transfer a history driving position of each external vehicle 4 to a remote server 5 or uploads a history driving position of each external vehicle 4 by using the Internet of Vehicles. In an embodiment, the communications module 40 may be a wireless communications module (for example, an antenna module, a WiFi module, a 3G/4G module), so as to connect to the Internet, so that the Internet of Vehicles or the remote server 5 may obtain a history driving trajectory of the external vehicle 4. In addition, in some embodiments, the communications module 40 may obtain a corresponding history driving trajectory according to the real-time vehicle position, and place the real-time vehicle position on the history driving trajectory. Alternatively, after the communications module 40 receives the history driving trajectory, a driver may move the vehicle 2 to place the real-time vehicle position on the history driving trajectory. The present invention is not limited thereto.

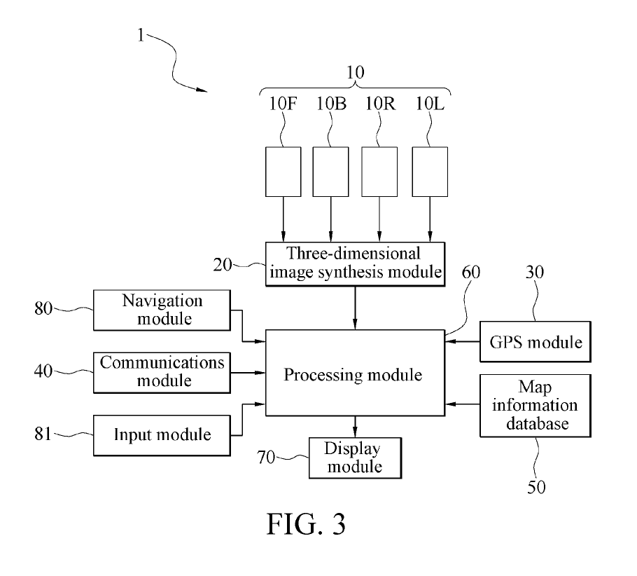

As shown in FIG. 3, in an embodiment, the three-dimensional driving navigation device 1 may further include an input module 81. The input module 81 may be specifically a touch control module or a voice module and may be connected to the communications module 40, so that a driver can input a search condition by using a touch control or voice manner. The search condition may be destination information (for example, the GPS position or name of a destination) or vehicle information (for example, a plate number). After receiving the search condition, the input module 81 may enable the communications module 40 to output the search condition, to make the history driving trajectory received by the communications module 40 correspond to the search condition. For example, the search condition input by the driver is a plate number. The remote server 5 may search, corresponding to the plate number, history driving trajectory of a corresponding external vehicle 4, and output the history driving trajectory to the communications module 40.

The map information database 50 stores map information. In an embodiment, the map information database 50 is located in a navigation device, and map information is built in the map information database 50. Alternatively, the three-dimensional driving navigation device 1 downloads the map information instantly from a remote end by using the communications module 40 and saves the map information in the map information database 50.

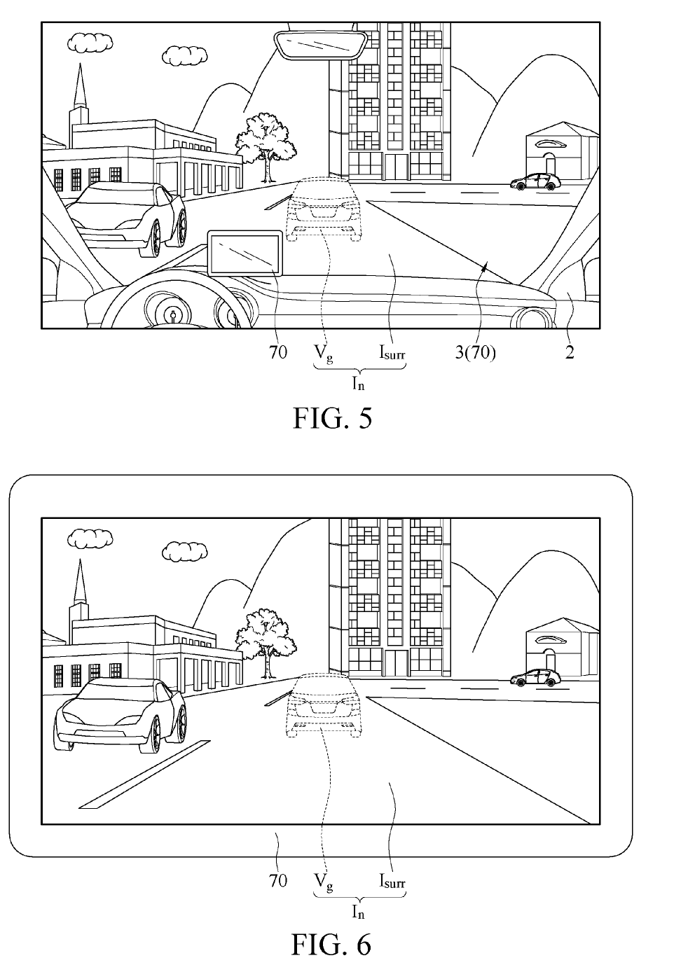

The processing module 60 may be specifically implemented by using a microcomputer, a processor or a dedicated chip and mounted in the vehicle 2. The processing module 60 is connected to the three-dimensional image synthesis module 20, the GPS module 30, the communications module 40, and the map information database 50. The processing module 60 receives the real-time vehicle position, the history driving trajectory, the map information, and the three-dimensional panoramic projection image Iₛᵤᵣᵣ. When the real-time vehicle position is located on the history driving trajectory, the processing module 60 compares the real-time vehicle position, the map information, and the history driving trajectory to generate a driving path. The processing module 60 superimposes a virtual guide image V_{g} on a position corresponding to the driving path in the three-dimensional panoramic projection image Iₛᵤᵣᵣ. In particular, after finishing comparison of the map information and the history driving trajectory, the processing module 60 may obtain a corresponding position of the history driving trajectory on an actual map, and then generate, according to the real-time vehicle position, a driving path with the real-time vehicle position being a starting point. The processing module 60 then superimposes the virtual guide image V_{g} on a road corresponding to the driving path in the three-dimensional panoramic projection image Iₛᵤᵣᵣ to form a three-dimensional navigation image Iₙ (referring to FIG. 5).

The display module 70 is specifically disposed inside the vehicle 2 (for example, on a dashboard) and connected to a display screen of the processing module 60. The display module 70 displays the three-dimensional panoramic projection image Iₛᵤᵣᵣ and the virtual guide image V_{g} (that is, the three-dimensional navigation image Iₙ). As shown in FIG. 5, in this embodiment, the display module 70 is embedded in a windshield 3 of the vehicle 2, and the three-dimensional panoramic projection image Iₛᵤᵣᵣ overlaps an external view in front of the vehicle 2. That is, the three-dimensional panoramic projection image Iₛᵤᵣᵣ is the same as that a driver sees through the windshield 3. The virtual guide image V_{g} is a three-dimensional virtual vehicle, and a fixed distance is kept between the virtual guide image V_{g} and the real-time vehicle position, so that the virtual guide image V_{g} can be continuously displayed in front of the vehicle 2. Therefore, the driver can intuitively follow this virtual vehicle during driving to travel, and the driver does not need to change a view position during driving, thereby further improving the driving safety. In some embodiments, the virtual guide image V_{g} may alternatively be another three-dimensional image (for example, a three-dimensional indicator).

Referring to both FIG. 5 and FIG. 6, in an embodiment, the display module 70 may be a head-up display or a display screen of a smart electronic product (for example, a smart phone or a tablet computer). This part is not limited thereto.

In conclusion, by means of image processing and synthesis, the three-dimensional driving navigation device in the embodiments of the present invention establishes a three-dimensional panoramic projection image, receives a history driving trajectory of another vehicle to generate the driving path, and superimposes a virtual guide image on a position corresponding to the driving path in the three-dimensional panoramic projection image, so as to enable a driver to intuitively travel according to a driving route of the other vehicle.

Further, for example, when a driver is unclear about the way and follows another vehicle of a friend to travel, if the driver loses the track of the vehicle of the friend because of traffic jams or an excessively fast speed of the vehicle of the friend, the three-dimensional driving navigation device 1 may receive a history driving trajectory of the vehicle of the friend to generate the three-dimensional navigation image Iₙ, so that the driver can intuitively follow a driving route of the friend to travel. Alternatively, if the driver wants to travel according to the driving route of the friend (for example, the driving route of the friend can enable the driver to reach the destination sooner or has relatively fast traffic), the three-dimensional driving navigation device 1 may receive the history driving trajectory of the vehicle of the friend to generate the three-dimensional navigation image Iₙ, so that the driver can intuitively follow the driving route of the friend to travel.

In an embodiment, the processing module 60 further superimposes a direction indication image V_{d} in the three-dimensional panoramic projection image according to the driving path, so that the driver can know in advance a subsequent moving direction in the virtual guide image V_{g} to react instantly, thereby further improving the driving safety. As shown in FIG. 7, in an embodiment, the direction indication image V_{d} is superimposed on a turn-signal light area of a virtual vehicle (the virtual guide image V_{g}). For example, if the virtual vehicle needs to turn right at a next road segment, the processing module 60 superimposes in advance a solid image or a flickering image on a right-turn-signal light area of the virtual vehicle, so that the driver can know in advance that the virtual vehicle is about to turn right and can react instantly.

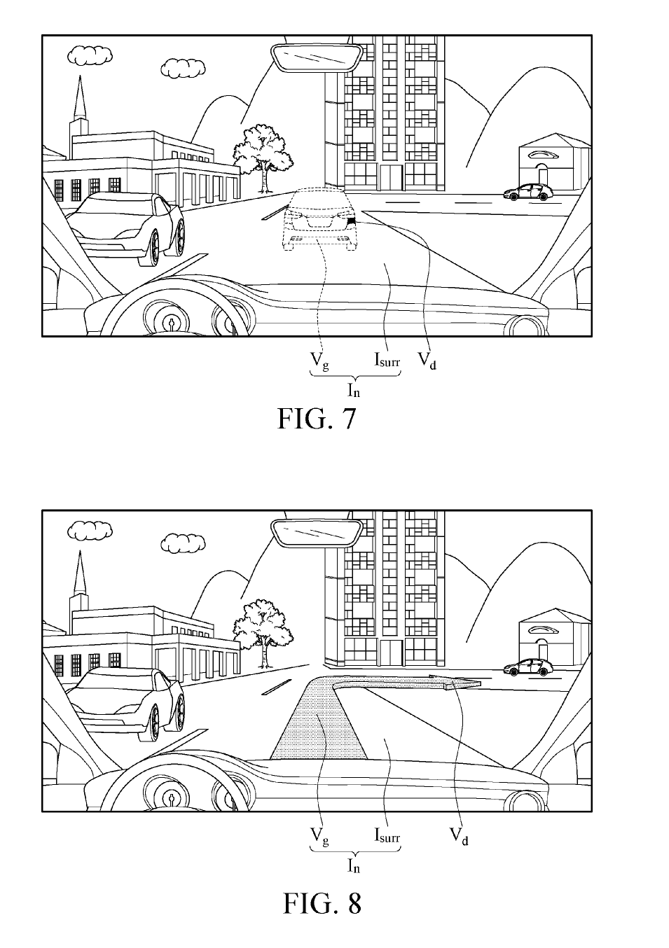

As shown in FIG. 8, in an embodiment, the virtual guide image V_{g} is a trajectory line, and is set along the driving path, so that the driver can intuitively follow the trajectory line to travel. The direction indication image V_{d} is labeled by using an arrow here, so that the driver can know in advance a subsequent moving direction.

In an embodiment, the processing module 60 outputs a departure signal when the real-time vehicle position departs from the driving path, so that a communications module 40 receives a corrected driving trajectory transferred from outside. The processing module 60 receives the corrected driving trajectory and compares the corrected driving trajectory with the map information to generate a corrected driving path. The processing module 60 superimposes the virtual guide image V_{g} on a position corresponding to the corrected driving path in the three-dimensional panoramic projection image Iₛᵤᵣᵣ.

For example, if the vehicle 2 changes to travel on another road segment because of some conditions (for example, the road is under construction or an accident occurs in front), the processing module 60 may determine, according to that the real-time vehicle position is not on the driving path, that the vehicle 2 departs from the driving path to output a departure signal, to drive the communications module 40 to download and receive, from the remote server 5 or Internet of Vehicles by using the Internet, a corrected driving trajectory transferred by another external vehicle 4. The corrected driving trajectory is also formed of a plurality of history driving positions (that is, previous GPS positions) of the other external vehicle 4, and the real-time vehicle position is located on the corrected driving trajectory.

The processing module 60 receives the corrected driving trajectory and then compares the map information to generate the corrected driving path, and the processing module 60 further superimposes the virtual guide image V_{g} (for example, the virtual vehicle or trajectory line) on a position corresponding to the corrected driving path in the three-dimensional panoramic projection image Iₛᵤᵣᵣ, to enable the driver to intuitively follow the virtual guide image V_{g} when traveling on the corrected driving path.

In some embodiments, the corrected driving path may be a path for returning to the original driving path, so that the driver can continue to follow the virtual guide image V_{g} of the original driving path to travel. Alternatively, the corrected driving path may be another driving path. That is, the driver no longer travels according to the driving path corresponding to the original history driving trajectory, but instead, travels according to a new driving path.

As shown in FIG. 3, in an embodiment, the three-dimensional driving navigation device 1 includes a navigation module 80 connected to the processing module 60. The processing module 60 outputs a departure signal when the real-time vehicle position departs from the driving path. The navigation module 80 receives the departure signal and correspondingly outputs a corrected navigation route for returning to the driving path. For example, the processing module 60 may determine, according to that the real-time vehicle position is not on the driving path, that the vehicle 2 departs from the driving path to output the departure signal. The navigation module 80 may generate the corrected navigation route according to the real-time vehicle position and GPS position on the driving path, so that the driver can return to the original driving path according to the corrected navigation route to continue to follow the virtual guide image V_{g} to travel. In an embodiment, the processing module 60 may alternatively superimpose the virtual guide image V_{g} on a position corresponding to the corrected navigation route in the three-dimensional panoramic projection image Iₛᵤᵣᵣ, to enable the driver to intuitively follow the virtual guide image V_{g} to move forward when traveling on the corrected navigation route.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A three-dimensional driving navigation device, applicable to a vehicle, the three-dimensional driving navigation device comprising:
a lens group, comprising a plurality of lenses, the lenses being respectively disposed on different positions around the vehicle, and respectively photographing a plurality of external images around the vehicle;
a three-dimensional image synthesis module, connected to the lens group, and the three-dimensional image synthesis module receiving the external images and synthesizing the external images into a three-dimensional panoramic projection image;
a GPS module, detecting and outputting a real-time vehicle position of the vehicle;
a communications module, receiving a history driving trajectory transferred from outside;
a map information database, storing map information;
a processing module, connected to the three-dimensional image synthesis module, the GPS module, the communications module, and the map information database, and the processing module receiving the real-time vehicle position, the history driving trajectory, the map information, and the three-dimensional panoramic projection image, and comparing the real-time vehicle position, the map information, and the history driving trajectory to generate a driving path, wherein the processing module superimposes a virtual guide image on a position corresponding to the driving path in the three-dimensional panoramic projection image; and
a display module, connected to the processing module, and the display module displaying the three-dimensional panoramic projection image and the virtual guide image.

2. The three-dimensional driving navigation device according to claim 1, wherein the virtual guide image is a three-dimensional image, and a fixed distance is kept between the virtual guide image and the real-time vehicle position.

3. The three-dimensional driving navigation device according to claim 1, wherein the virtual guide image is a trajectory line, and the virtual guide image is set along the driving path.

4. The three-dimensional driving navigation device according to claim 1, wherein the processing module outputs a departure signal when the real-time vehicle position departs from the driving path, so that the communications module receives a corrected driving trajectory transferred from outside, the processing module receives the corrected driving trajectory and compares the corrected driving trajectory with the map information to generate a corrected driving path, and the processing module superimposes the virtual guide image on a position corresponding to the corrected driving path in the three-dimensional panoramic projection image.

5. The three-dimensional driving navigation device according to claim 4, wherein the corrected driving path is a path for returning to the driving path, or the corrected driving path is another driving path.

6. The three-dimensional driving navigation device according to claim 1, further comprising a navigation module, connected to the processing module, wherein the processing module outputs a departure signal when the real-time vehicle position departs from the driving path, the navigation module receives the departure signal and correspondingly outputs a corrected navigation route for returning to the driving path.

7. The three-dimensional driving navigation device according to claim 6, wherein the processing module further superimposes the virtual guide image on a position corresponding to the corrected navigation route in the three-dimensional panoramic projection image.

8. The three-dimensional driving navigation device according to claim 1, further comprising an input module, connected to the communications module, wherein the input module receives a search condition, the communications module outputs the search condition, and the history driving trajectory corresponds to the search condition.

9. The three-dimensional driving navigation device according to claim 1, wherein the display module is embedded in a windshield of the vehicle, and the three-dimensional panoramic projection image overlaps an external view in front of the vehicle.

10. The three-dimensional driving navigation device according to claim 1, wherein the processing module further superimposes a direction indication image in the three-dimensional panoramic projection image according to the driving path.
